(19) United States
(12) Patent Application Publication
(10) Pub. No.: US 2023/0321532 A1
(43) Pub. Date: Oct. 12, 2023

(54) GAME PICTURE DISPLAY METHODS AND APPARATUSES, DEVICE AND STORAGE MEDIUM

(71) Applicant: TENCENT TECHNOLOGY (SHENZHEN) COMPANY LIMITED, Shenzhen (CN)

(72) Inventor: Chuang BEN, Shenzhen (CN)

(73) Assignee: TENCENT TECHNOLOGY (SHENZHEN) COMPANY LIMITED, Shenzhen (CN)

(21) Appl. No.: 18/332,904

(22) Filed: Jun. 12, 2023

Related U.S. Application Data
(63) Continuation of application No. PCT/CN2022/108168, filed on Jul. 27, 2022.

(30) Foreign Application Priority Data
Aug. 31, 2021 (CN) 202111013776.3

(51) Int. Cl. A63F 13/355; A63F 13/335; A63F 13/533; A63F 13/86

(52) U.S. Cl. CPC A63F 13/355; A63F 13/86; A63F 13/533; A63F 13/335

(57) ABSTRACT

Game picture display methods and apparatuses, a device and a storage medium are provided, and belong to the technical field of livestreaming. The method includes obtaining live operation information associated with a first player and a second player of a game session from a game server; generating a first video stream corresponding to the first player and a second video stream corresponding to the second player based on the live operation information; and distributing the first video stream to a first push address and the second video stream to a second push address.

### CROSS-REFERENCES TO RELATED APPLICATIONS

This application is a continuation application of International Application No. PCT/CN2022/108168, filed with the China National Intellectual Property Administration on Jul. 27, 2022, which claims priority to China Patent Application No. 202111013776.3, filed with the China National Intellectual Property Administration on Aug. 31, 2021, the disclosure of which are incorporated herein in their entireties.

### FIELD

The disclosure relates to the technical field of livestreaming, particularly to game picture display methods and apparatuses, a device and a storage medium.

### BACKGROUND

With the development of computer technologies, more and more users watch livestreaming videos through various types of computer devices. Game livestreaming is livestreaming type with high popularity, and users may watch game livestreaming videos to have fun. At present, pictures of game livestreaming refer to game pictures displayed on a screen of a livestreamer, that is, a livestreaming server of a livestreaming platform pushes game pictures displayed on the screen of the livestreamer to users.

### SUMMARY

Embodiments the disclosure provide game picture display methods and apparatuses, a device and a storage medium. The technical solutions are as follows:

According to an aspect, a game picture display method is provided, the method may include obtaining live operation information associated with a first player and a second player of a game session from a game server; generating a first video stream corresponding to the first player and a second video stream corresponding to the second player based on the live operation information; and distributing the first video stream to a first push address and the second video stream to a second push address.

According to an aspect, an apparatus for livestreaming a game may be provided. The apparatus may include at least one memory configured to store program code; and at least one processor configured to read the program code and operate as instructed by the program code. The program code may include first obtaining code configured to cause the at least one processor to obtain live operation information associated with a first player and a second player of a game session from a game server; first generating code configured to cause the at least one processor to generate a first video stream corresponding to the first player and a second video stream corresponding to the second player based on the live operation information; and first distributing code configured to cause the at least one processor to distribute the first video stream to a first push address and the second video stream to a second push address.

According to an aspect, a non-transitory computer readable medium storing instructions may be provided. The non-transitory computer readable medium storing instructions, when executed by at least one processor for livestreaming a game, cause the at least one processor to obtain live operation information associated with a first player and a second player of a game session from a game server; generate a first video stream corresponding to the first player and a second video stream corresponding to the second player based on the live operation information; and distribute the first video stream to a first push address and the second video stream to a second push address.

According to an aspect, a computer device may be provided. The computer device may include one or more processors and one or more memories, the one or more memories storing at least one computer program which is loaded and executed by the one or more processors to implement the game picture display methods.

According to an aspect, a computer-readable storage medium may be provided, which may store at least one computer program. The computer program may be loaded and executed by a processor to implement the game picture display methods.

According to an aspect, a computer program product or a computer program may be provided. The computer program product or the computer program may include a program code. The program code may be stored in a computer-readable storage medium, and a processor of a computer device may read the program code from the computer-readable storage medium. The processor may execute the program code to cause the computer device to implement the game picture display methods.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

### BRIEF DESCRIPTION OF THE DRAWINGS

FIG. 1 is a schematic diagram of an implementation environment of a game picture display method provided according to an embodiment the disclosure.

FIG. 2 is a flow diagram of a game picture display method provided according to an embodiment the disclosure.

FIG. 3 is a flow diagram of a game picture display method provided according to an embodiment the disclosure.

FIG. 4 is a schematic diagram of an account binding page provided according to an embodiment the disclosure.

FIG. 5 is a schematic diagram of an account binding page provided according to an embodiment the disclosure.

FIG. 6 is a flow diagram of a game account binding method provided according to an embodiment the disclosure.

FIG. 7 is a flow diagram of a push address obtaining method provided according to an embodiment the disclosure.

FIG. 8 is a schematic diagram of a video stream pushing method provided according to an embodiment the disclosure.

FIG. 9 is a schematic diagram of a livestreaming page provided according to an embodiment the disclosure.

FIG. 10 is a schematic diagram of a livestreaming page provided according to an embodiment the disclosure.

FIG. 11 is a schematic diagram of a livestreaming page provided according to an embodiment the disclosure.

FIG. 12 is a flow diagram of a game picture display method provided according to an embodiment the disclosure.

FIG. 13 is a schematic structural diagram of a game picture display apparatus provided according to an embodiment the disclosure.

FIG. 14 is a schematic structural diagram of a game picture display apparatus provided according to an embodiment the disclosure.

FIG. 15 is a schematic structural diagram of an audience terminal according to an embodiment the disclosure.

FIG. 16 is a schematic structural diagram of a livestreaming middle ground provided according to an embodiment the disclosure.

### DETAILED DESCRIPTION

To make the objectives, technical solutions, and advantages the disclosure clearer, the following further describes implementations the disclosure in detail with reference to the accompanying drawings.

The terms “first”, “second”, and the like are used herein to distinguish the same or similar items that perform substantially the same function, and it is to be understood that the terms “first”, “second”, and “nth” do not have a logical or chronological dependency on each other or limit the number and order of execution.

The term “at least one” in the disclosure means one or more, and the term “plurality” means two or more. For example, a plurality of participants of a game battle means two or more participants.

In the related technology, pictures (or images) of game livestreaming actually refer to game pictures displayed on a screen of a livestreamer, that is, a livestreaming server of a livestreaming platform pushes game pictures displayed on the screen of the livestreamer to users.

In this case, the users may only follow views of the livestreamer to watch a game livestreaming video, and cannot switch the views to other views to watch the game livestreaming video, resulting in a poor experience of the users in watching game livestreaming videos.

In view of this, embodiments the disclosure relate to game picture display methods, which may support various game picture watching manners at different views, which are described below.

Cloud gaming, also referred to as game on demand, is an online gaming technology based on a cloud computing technology. By the cloud gaming technology, a thin client with limited graphics processing and data operation capabilities may run high-quality games. In a cloud gaming scene, a game is not run in a player gaming terminal, but is run in a cloud gaming server, and the cloud gaming server renders the gaming scene into a video/audio stream for transmission to the player gaming terminal via a network. The player gaming terminal does not have to have extremely high graphics operation and data processing capabilities, but only needs to have a basic streaming media playing capability and a capability of obtaining input instructions of a player and transmitting same to the cloud gaming server.

Virtual scene: It is a virtual scene displayed (or provided) by an application when the application program is run on a terminal. Optionally, the virtual scene is a real-world simulation environment, or a semi-simulation semi-fiction virtual environment, or a purely fictional virtual environment. Optionally, the virtual scene is any one of a two-dimensional virtual scene, a 2.5-dimensional virtual scene or a three-dimensional virtual scene, and the embodiments the disclosure do not limit a dimension of a virtual scene. For example, a virtual scene includes a sky, a land, an ocean, and the like. The land includes environmental elements such as a desert and a city. A user may control a virtual object to move in the virtual scene.

Virtual object: It refers to a movable object in a virtual scene. Optionally, the movable object is a virtual person, a virtual animal, an animation character, and the like. For example: a person, an animal, a plant, an oil bucket, a wall, a stone and the like displayed in a virtual scene. For example, the virtual object is a virtual image in the virtual scene for representing a user. Optionally, a virtual scene includes a plurality of virtual objects. Each virtual object has its own shape and volume in the virtual scene, occupying part of a space in the virtual scene.

A shooting game is taken as an example. A user may control a virtual object to freely fall, glide or open a parachute to fall, and the like in the sky of a virtual scene and to run, jump, crawl, bend forward, and the like on land, and may also control the virtual object to swim, float, dive, or the like in the ocean. Of course, the user may also control the virtual object to move in the virtual scene in a virtual carrier. For example, the virtual carrier is a virtual automobile, a virtual aircraft, a virtual yacht, and the like. The above-mentioned scenes are merely exemplified, and the embodiments the disclosure do not specifically limit this. In some embodiments, a user may also control a virtual object to interact with other virtual objects via an interaction prop. For example, the interaction prop is a throwing type interaction prop, a shooting type interaction prop, and the like, and the disclosure does not specifically define the type of the interaction prop.

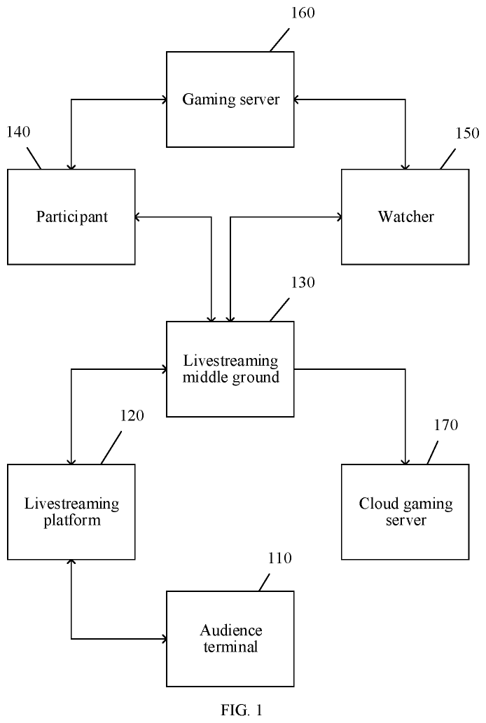

FIG. 1 is a schematic diagram of an implementation environment of a game picture (or a game image) display method provided according to an embodiment the disclosure. Referring to FIG. 1, the implementation environment includes an audience terminal 110, a livestreaming platform 120, a livestreaming middle ground 130, a participant 140 of target battle (hereinafter simply referred to as participant 140), a watcher 150 of target battle (hereinafter simply referred to as watcher 150), a gaming server 160 and a cloud gaming server 170.

The audience terminal 110 is an exemplary illustration of a terminal. The livestreaming platform 120 is an exemplary illustration of a livestreaming server, and is configured to provide a livestreaming service to the terminal. The livestreaming middle ground 130 is an exemplary illustration of a livestreaming control server, and is configured to separately pro vide a plurality of different livestreaming servers with game pictures at different views in the same game battle.

In some embodiments, the audience terminal 110, the livestreaming platform 120, the livestreaming middle ground 130, the participant 140, the watcher 150, the gaming server 160 and the cloud gaming server 170 are nodes in a blockchain system, and data transmitted between the audience terminal 110, the livestreaming platform 120, the livestreaming middle ground 130, the participant 140, the watcher 150, the gaming server 160 and the cloud gaming server 170 is also stored on a blockchain.

The audience terminal 110 is connected to the livestreaming platform 120 through a wireless or wired network. Optionally, the audience terminal 110 is, but not limited to, a smart phone, a tablet computer, a notebook computer, a desktop computer, a smart watch, and the like. An application program that supports livestreaming playing is installed and run in the audience terminal 110. The audience terminal 110 may obtain a livestreaming video stream from the livestreaming platform 120, and decode the obtained livestreaming video stream into pictures for displaying by using the application program that supports livestreaming playing, so that a user may watch livestreaming by using the application program. When the livestreaming video stream transmitted by the livestreaming platform 120 to the audience terminal 110 is a livestreaming video stream related to game livestreaming, the audience terminal 110 may also generate a game picture on the basis of the obtained livestreaming video stream and display the game picture in a livestreaming interface, and the user may watch the game livestreaming through the livestreaming interface. For example, the livestreaming interface includes a livestreaming page displayed in a browser application, or a User Interface (UI) displayed in an application program.

Optionally, the audience terminal 110 generally refers to one of a plurality of audience terminals, and this embodiment is exemplified with the audience terminal 110 only.

The livestreaming platform 120 is a server, namely a livestreaming server, that provides livestreaming-related services, or is a server that provides a background service for an application program which is run on the audience terminal 110 and supports livestreaming playing. The livestreaming platform 120 is connected to the livestreaming middle ground 130 via a wireless network or a wired network. The livestreaming platform 120 may obtain a video stream from the livestreaming middle ground and forward the video stream to the audience terminal 110 for playing. In some embodiments, the livestreaming platform 120 may perform secondary processing on the video stream obtained from livestreaming middle ground 130, for example, may divide the video stream obtained from the livestreaming middle ground 130 into different definitions for secondary transcoding for use by audience terminals requiring different definitions. Or, the livestreaming platform 120 may watermark the video stream obtained from the livestreaming middle ground 130 to prevent piracy and the like. Or, the livestreaming platform 120 may also store the video stream obtained from livestreaming middle ground 130 for subsequent playback.

As a transfer station of data processing during livestreaming, the livestreaming middle ground 130 is connected to the livestreaming platform 120, the participant 140, the watcher 150 and the cloud gaming server 170 via the wireless network or the wired network. That is, the livestreaming middle ground 130 may perform data interaction with the livestreaming platform 120, the participant 140, the watcher 150 and the cloud gaming server 170. The livestreaming middle ground 130 may provide a transfer service of data processing during the livestreaming for various different livestreaming platforms 120. Therefore, the livestreaming middle ground 130 refers to a livestreaming control server. In general, the livestreaming control server may allocate game pictures at different views in the same game battle to different livestreaming platforms 120, namely, different livestreaming platforms.

The participant 140 is connected to the gaming server 160 by using a wireless network or a wired network. Optionally, the participant 140 is, but not limited to, a smart phone, a tablet computer, a notebook computer, a desktop computer, and the like. An application program that supports displaying a virtual scene is installed and run in the participant 140. The application program that supports displaying a virtual scene is also a game application program. The participant 140 may display a virtual scene by running the game application program. A first virtual object controlled by the participant 140 is displayed in the virtual scene. The participant 140 may control, in this virtual scene, the first virtual object to interact with virtual objects controlled by other participants. In some embodiments, the participant 140 refers to a gaming terminal used by a game player. A case where a plurality of participants 140 control virtual objects to interact with each other in the virtual scene is referred to as a game battle. The plurality of participants 140 fight each other through the gaming server 160, that is, the plurality of participants 140 all transmit control information of the virtual objects to the gaming server 160, and the gaming server 160 performs background processing, generates game data on the basis of the control information, and transmits the game data to all the participants 140. After the participants 140 receive the game data, rendering is performed on the basis of the game data, to generate game pictures associated with all the participants 140.

The watcher 150 is connected to the gaming server 160 via a wireless network or a wired network. Optionally, the watcher 150 is, but not limited to, a smart phone, a tablet computer, a notebook computer, a desktop computer, and the like. An application program that supports displaying a virtual scene is installed and run in the watcher 150. The application program that supports displaying a virtual scene is the same as the application program run in the participant 140, or is an application program associated with the application program run in the participant 140. The watcher 150 may obtain data of a current game battle from the gaming server, and generate game pictures on the basis of the obtained data, to watch the game battle. Compared with the participant 140, the watcher 150 does not directly participate in the battle, in other words, the watcher 150 does not control the virtual objects in the virtual scene. The watcher 150 may display game pictures corresponding to different positions in the virtual scene on the basis of user operations. In some embodiments, the watcher 150 is a terminal used by a game judge or a game commentator.

The gaming server 160 provides a background service of virtual scene displaying.

The cloud gaming server 170 is connected to the participant 140 via a wired or wireless network. The cloud gaming server 170 may obtain control information of the virtual object from the participant 140, and directly render the game pictures of the participant 140 on the basis of the control information. Compared with the gaming server 160, the cloud gaming server 170 may directly obtain the game pictures, while the gaming server 160 obtains the game-related data. The rendering of the game pictures is achieved by the participant 140 on the basis of the data transmitted by the gaming server 160. This may enable the gaming server 160 to focus on processing the game-related data to provide faster game services for the various participants 140, to improve the gaming experiences of the various participants 140. The cloud gaming server 170 may render the game pictures on its own for watching by the audience terminal 110.

Any one of the livestreaming platform 120, namely, a livestreaming server, the livestreaming middle ground 130, namely, a livestreaming control server, the gaming server 160 or the cloud gaming server 170 is an independent physical server, or a server cluster or a distributed system formed by a plurality of physical servers, or a cloud server that provides basic cloud computing services such as cloud services, cloud databases, cloud computing, cloud functions, cloud storage, network services, cloud communication, middleware services, domain name services, security services, Content Delivery Networks (CDNs), big data, and artificial intelligence platforms.

After the game picture display method provided by this embodiment the disclosure is introduced, application scenes of the game picture display method provided by the embodiments the disclosure will be described in conjunction with the above-mentioned implementation environment. In the following descriptions, an audience terminal refers to the audience terminal 110 of the above-mentioned implementation environment. The audience terminal is an exemplary description of a terminal for watching game livestreaming. A livestreaming platform refers to the livestreaming platform 120 of the above-mentioned implementation environment. The livestreaming platform is an exemplary description of a livestreaming server for providing a livestreaming service for the terminal. A livestreaming middle ground refers to the livestreaming middle ground 130 of the above-mentioned implementation environment. The livestreaming middle ground is an exemplary description of a livestreaming control server for providing different livestreaming servers with game pictures at different views in the same game battle. A participant of a target battle refers to the participant 140 of the above-mentioned implementation environment. The participant is an exemplary description of a gaming terminal directly participating in the target battle. The watcher of the target battle refers to the watcher 150 of the above-mentioned implementation environment. The watcher is an exemplary description of a livestreamer terminal that watching the target battle. A gaming server refers to the gaming server 160 of the implementation environment. A cloud gaming server refers to the cloud gaming server 170 of the implementation environment.

The game picture display method provided by this embodiment the disclosure may be applied to various types of gaming scenes, such as a First-person Shooting (FPS) game, or a Third-Personal Shooting (TPS) game, or a Multiplayer Online Battle Arena (MOBA), or a self-moving chess game, and this embodiment the disclosure does not limit this.

An example of applying the game picture display method provided by this embodiment the disclosure to a MOBA type game is taken as an example. One MOBA game includes 10 participants, and the 10 participants are divided into two teams for fighting. Before the game starts, the 10 participants may bind game accounts with the livestreaming middle ground through an account binding interface. After the binding, the livestreaming middle ground may obtain control information of the 10 participants. After the binding of the game accounts is completed, the 10 participants initiate an application program of the game, and log in their own game accounts in the application program of the game. After login, the 10 participants join the same game battle. The livestreaming middle ground transmits a push address obtaining request to the livestreaming platform, and the push address obtaining request carries the 10 game accounts bound with the livestreaming middle ground. After obtaining the push address obtaining request, the livestreaming platform generates 10 push addresses separately associated with the 10 game accounts. The 10 push addresses are separately used for obtaining respective video streams of the 10 game accounts, that is, video streams separately associated with the 10 participants. After the game starts, the 10 participants upload operation information to the livestreaming middle ground in real time. The livestreaming middle ground transmits the operation information uploaded by the 10 participants to the cloud gaming server. The cloud gaming server renders a virtual scene of the game on the basis of the operation information separately uploaded by the 10 participants to obtain the 10 video streams separately associated with the 10 participants. Each video stream carries a game picture of the game battle watched in a view of the associated participant. The cloud gaming server transmits the 10 video streams to the livestreaming middle ground, and the livestreaming middle ground pushes the 10 video streams to the livestreaming platform on the basis of the 10 push addresses. At the same time, the livestreaming middle ground obtains a game picture uploaded by the watcher, and transmits the game picture uploaded by the watcher to the livestreaming platform, and the livestreaming platform transmits the game picture uploaded by the watcher to the audience terminal. The audience terminal may watch the game picture uploaded by the watcher in a livestreaming page. The livestreaming page is an exemplary description of a livestreaming interface. A user may operate a view switching control displayed on the livestreaming page to watch the game battle at a view of a first participant among the 10 participants. The audience terminal transmits a view switching instruction to the livestreaming platform in response to a first operation performed on the view switching control. The view switching instruction carries an identifier of the first participant associated with the first operation. After receiving the view switching instruction, the livestreaming platform obtains the identifier of the first participant from the view switching instruction, and pushes the video stream associated with the first participant to the audience terminal. After receiving the video stream associated with the first participant, the watcher may display the game picture at the view of the first participant in the livestreaming page on the basis of the video stream associated with the first participant, thereby switching the view of the watcher to the view of the first participant.

After the implementation environment and the application scene of this embodiment the disclosure, the following describes the game picture display method provided by this embodiment the disclosure.

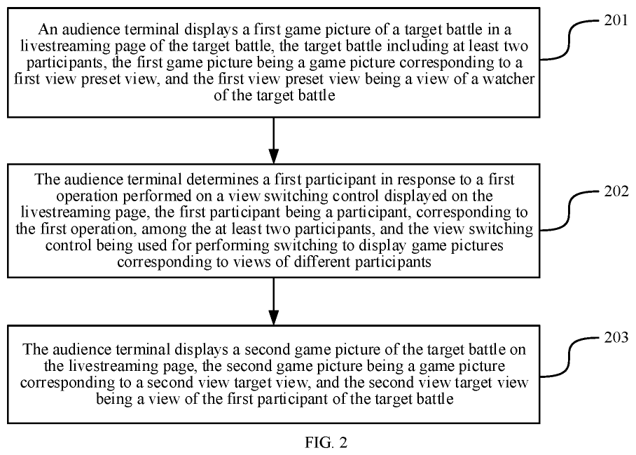

FIG. 2 is a flow diagram of a game picture display method provided according to an embodiment the disclosure. The game picture display method is performed by a terminal. An example of using a terminal of an executive body as an audience terminal is taken. Referring to FIG. 2, the method includes:

201. The audience terminal displays a first game picture of the target battle in a livestreaming page of a target battle, the target battle including at least two participants, the first game picture being a game picture corresponding to a preset view, and the preset view being a view of a watcher of the target battle.

In the above-mentioned operation 201, namely, in one possible implementation where the terminal displays the first game picture in the livestreaming interface of the target battle, a livestreaming page is an exemplary description of the livestreaming interface. The livestreaming interface includes a web page for displaying a livestreaming video stream in a browser application program, and also includes a UI interface for displaying a livestreaming video stream in a livestreaming application program. An example of taking a livestreaming interface as a livestreaming page is taken for description. This embodiment the disclosure does not make specific restrictions on the type of the livestreaming interface.

The target battle is a game battle. Optionally, at least two participants included in the target battle are participants of the same team or participants of different teams. If the at least two participants are participants of the same team, the target battle refers to a battle in which the at least two participants jointly fight against a Non-Player Character (NPC) in the game. If the at least two participants are participants of different teams, the target battle refers to a battle in which the participants of different teams fight against each other.

The first game picture is a game picture at the preset view, and the preset view is the view of the watcher of the target battle. In other words, the first game picture is a game picture associated with the watcher of the target battle, namely, a game picture displayed by the watcher. A user watches the first game picture through the livestreaming page, namely, a user watches the target battle at the view of the watcher.

202. The audience terminal determines a first participant in response to a first operation performed on a view switching control displayed on the livestreaming page, the first participant being a participant, corresponding to the first operation, among the at least two participants, and the view switching control being used for performing switching to display game pictures corresponding to views of different participants.

In the above operation 202, namely, in one possible implementation where the terminal determines the first participant in response to the first operation performed on the view switching control displayed on the livestreaming interface, the first participant is the participant, associated with the first operation, among the at least two participants, namely, a participant selected by the user through the view switching control, and the participants of the target battle are terminals that control virtual objects to fight against each other in a virtual scene of the target battle. The user selects the first participant through the view switching control, which means that the user intends to watch the target battle at the view of the first participant. The view switching control is also used for switching game pictures associated with the views of the watcher and the participants in addition to performing switching to display game pictures associated with views of different participants.

203. The audience terminal displays a second game picture of the target battle on the livestreaming page, the second game picture being a game picture corresponding to a target view, and the target view being a view of the first participant of the target battle.

In the above-mentioned operation 203, namely, in one possible implementation where the terminal displays the second game picture on the livestreaming interface, the second game picture is the game picture at the target view, that is, the game picture associated with the view of the first participant, so that the user watches the second game picture in the livestreaming page, that is, the user watches the target battle at the view of the first participant.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

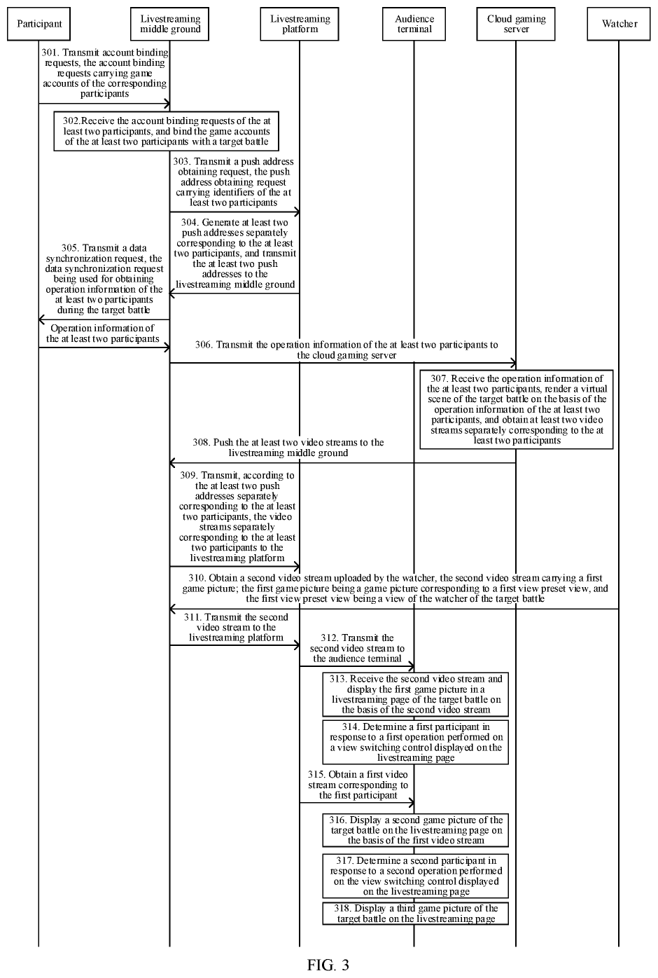

The above-mentioned operations 201-203 briefly describe the game picture display method provided by this embodiment the disclosure. The game picture display method provided by this embodiment the disclosure will be described more clearly below in combination with the above implementation environment and some examples. Referring to FIG. 3, the method includes:

301. The at least two participants of the target battle separately transmit account binding requests to a livestreaming middle ground, the account binding requests carrying game accounts of the corresponding participants.

The above at least two participants refer to at least two gaming terminals participating in the target battle, and the gaming terminal of any one participant may control any virtual object participating in the target battle to do activities in the virtual scene of the target battle.

The above livestreaming middle ground refers to a livestreaming control server. After the participants bind the game accounts in the livestreaming middle ground, the livestreaming middle ground may provide different livestreaming platforms, namely, livestreaming servers, with game pictures associated with the game accounts bound by the participants. The game picture associated with the game account bound by each participant refers to a game picture of the target battle watched at a view of the participant.

The target battle is a game battle. The at least two participants of the target battle may control different virtual objects to fight against each other in the virtual scene of the target battle, and the virtual scene of the target battle is also a gaming scene. The participants of the target battle are terminals used by players participating in the target battle, and the game accounts of the participants are game accounts used during the participation in the target battle.

In some embodiments, one game account includes a plurality of game characters. Each game character corresponding to one gaming server. Game data of different game characters is stored in corresponding gaming servers

Since methods for transmitting the account binding requests to the livestreaming middle ground by the at least two participants of the target battle belong to the same technical concept, one of the at least two participants is taken as an example for description below.

In some embodiments, the participant displays an account binding page. The account binding page is an account binding page provided by a livestreaming middle ground. In response to an account binding operation performed on the account binding page, the participant transmits an account binding request to the livestreaming middle ground. The account binding request carries a game account, and the game account is a game account of the participant participating in a target battle.

In this implementation, the participant of the target battle may bind the game account by using the account binding page provided by the livestreaming middle ground, so that the account binding efficiency is relatively high.

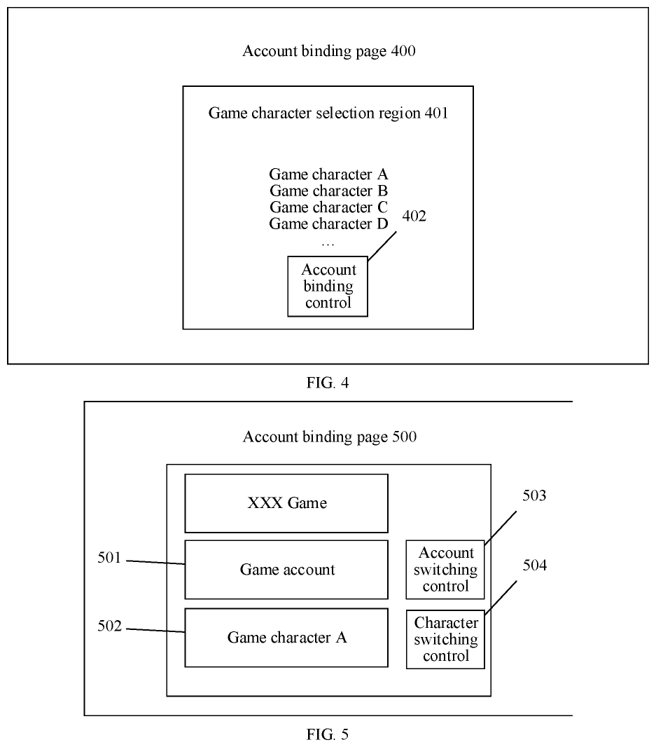

For example, the participant displays the account binding page, and an account inputting region, a password inputting region and a login control are displayed in the account binding page. A user using the participant may input the game account to the account inputting region and input a password of the game account to the password inputting region. After the account and the password are inputted, in response to a click operation performed on the login control, the participant transmits a login request to the livestreaming middle ground. The login request carries the game account inputted to the account inputting region and the password inputted to the password inputting region. After receiving the login request, the livestreaming middle ground obtains the game account and the password from the login request, and the livestreaming middle ground verifies the game account and the password. In a case that the verification succeeds, the livestreaming middle ground transmits login success information to the participant. The login success information carries an identifier of at least one game character associated with the game account. The participant receives the login success information, and displays, in the account binding page, the identifier of the at least one game character associated with the game account. In a case that the identifier of the at least one game character displayed in the account binding page is selected, the participant transmits the account binding request to the livestreaming middle ground. The account binding request carries the identifier of the selected game character. For example, referring to FIG. 4, the participant receives the login success information, and displays, in an account binding page 400, a game character selection region 401 corresponding to the game account. The game character selection region 401 displays an identifier of at least one game character. In response to a click operation performed on an account binding control 402, the participant transmits an account binding request to the livestreaming middle ground. The account binding request carries an identifier of a selected game character.

In some embodiments, after the participant logs in to the livestreaming middle ground, the participant may also switch game accounts logged in to the livestreaming middle ground in the following manner. An account switching control is displayed in the account binding page, and the account switching control is used for switching the game accounts logged in to the livestreaming middle ground. Referring to FIG. 5, a game account 501 currently logged in to the livestreaming middle ground and an identifier 502 of a game character bound to a game middle ground under the game account 501 are displayed in an account binding page 500, and an account switching control 503 is also displayed in the account binding page 500. In response to an operation performed on the account switching control 503, the participant displays a historical character selection region in the account binding page 500. Game accounts of the participant historically logged in to the livestreaming middle ground are displayed in the historical account selection region. In response to a selection operation performed on the historical character selection region, the participant transmits an account switching request to the livestreaming middle ground, and the account switching request carries a game account selected in the historical character selection region. After receiving the account switching request, the livestreaming middle ground obtains the game account from the account switching request, and transmits switching success information to the participant. The switching success information carries an identifier of a game character bound to the livestreaming middle ground under the game account. In response to receiving the switching success information, the participant displays, in the account binding page, the switched game account and the identifier of the game character bound to the livestreaming middle ground under the switched game account.

In some embodiments, the participant may also adjust a binding relationship between the game character under the game account and the livestreaming middle ground in the following manner. A character switching control is displayed in the account binding page. In response to an operation performed on the character switching control, the participant displays a historical character selection region in a character binding page. A plurality of game characters under the currently logged in game account of the participant are displayed in the historical character selection region. Referring to FIG. 5, a game account 501 currently logged in to the livestreaming middle ground and an identifier 502 of a game character bound to a game middle ground under the game account 501 are displayed in an account binding page 500, and a character switching control 504 is also displayed in the account binding page 500. In response to an operation performed on the character switching control 504, the participant displays a historical character selection region in the account binding page 500. Various game characters that had been bound to game accounts of the participant historically logged in to the livestreaming middle ground are displayed in the historical character selection region. In response to a selection operation performed on the historical character selection region, the participant transmits a character switching request to the livestreaming middle ground, and the character switching request carries a game character selected in the historical character selection region. After receiving the character switching request, the livestreaming middle ground obtains the game character from the character switching request, replaces the game character for the game character of the game account bound to the livestreaming middle ground, and transmits switching success information to the participant. In response to receiving the switching success information, the participant displays, in the character binding page, the switched game account and the identifier of the game character bound to the livestreaming middle ground under the switched game account.

302. The livestreaming middle ground receives the account binding requests of the at least two participants, and binds the game accounts of the at least two participants with the target battle.

Since methods for binding the game accounts of the at least two participants to the target battle by the livestreaming middle ground belong to the same technical concept, one of the at least two participants is taken as an example for description below.

In some embodiments, the account binding request carries an identifier of a game character. The identifier of the game character is an identifier of the game character selected, in the account binding page, by the participant that initiates the account binding request. The livestreaming middle ground receives the account binding request, and obtains the identifier of the game character from the account binding request. The livestreaming middle ground binds the identifier of the game character with the target battle, that is, binds the game account with the target battle.

In some embodiments, the livestreaming middle ground transmits, after successfully binding the identifier of the game character with the target battle, a binding success message to the participant that initiates the account binding request. After receiving the binding success message, the participant displays the successfully bound game account and the identifier of the game character in the account binding page.

In some embodiments, if the participant still needs to use the game account bound with the livestreaming middle ground in subsequent battles, the participant does not need to perform an account binding operation again. If the participant intends to use other game accounts in subsequent battles, the account switching method described above in operation 301 may be used to switch the game account.

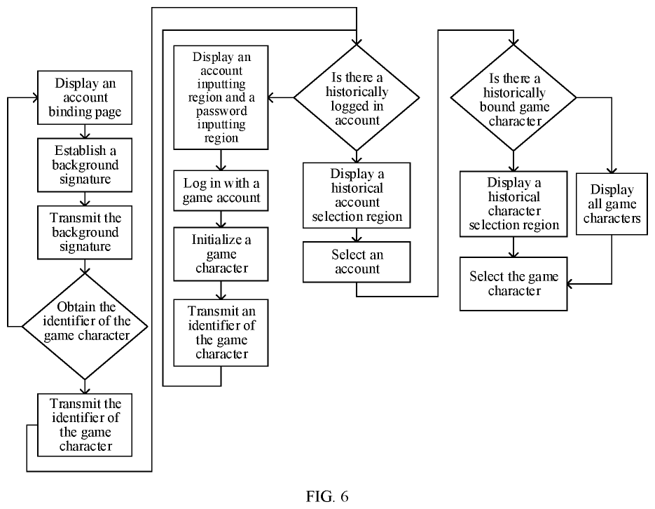

The game account binding method in operations 301 and 302 described above will be described below with reference to FIG. 6.

Referring to FIG. 6, the participant displays the account binding page. The participant establishes a background signature which carries a game account and a password of the game account. The participant transmits the background signature to the livestreaming middle ground, and the livestreaming middle ground verifies the game account and the corresponding password. After the verification succeeds, the livestreaming middle ground obtains an identifier of a game character under the game account, and transmits the identifier of the game character to the participant. If the livestreaming middle ground fails to obtain the identifier of the game character under the game account, the livestreaming middle ground transmits game character obtaining failure information to the participant, and the participant re-establishes a background signature on the basis of the game character obtaining failure information. After the game account is successfully bound to the livestreaming middle ground, if the participant intends to adjust the game account bound to the livestreaming middle ground, the participant determines, in response to a click operation performed on an account switching control displayed in the account binding page, whether there is a historically logged in game account. If there is a historically logged in game account, the participant displays a historical character selection region. Game accounts of the participant historically logged in to the livestreaming middle ground are displayed in the historical character selection region. In response to a selection operation performed on the historical character selection region, the participant transmits an account switching request to the livestreaming middle ground, and the account switching request carries a game account selected in the historical character selection region. The livestreaming middle ground switches the logged in game account on the basis of the account switching request. If there is no historically logged in game account, the participant displays an account inputting region, a password inputting region and a login control. A user of the participant needs to input a new game account to the account inputting region and input a password of the new game account to the password inputting region. The new game account is bound with the livestreaming middle ground by clicking the login control. After the binding, the game middle ground initializes a game character under the game account, that is, an identifier of the game character under the game account is obtained. If the participant intends to adjust a binding relationship between the game character under the game account and the livestreaming middle ground after logging in to the livestreaming middle ground, the participant determines, in response to an operation performed on a character switching control displayed in the account binding page, whether there is a historically bound game character under the currently logged in game account. If there is a historically bound game character under the currently logged in game account, the participant displays a historical character selection region in the character binding page. A plurality of game characters under the currently logged in game account of the participant are displayed in the historical character selection region. If there is no historically bound game character under the currently logged in game account, all game characters under the game account are displayed in the historical character selection region for selection by the user. In response to a selection operation performed on the historical character selection region, the participant transmits a character switching request to the livestreaming middle ground, and the character switching request carries the game account selected in the historical character selection region. The livestreaming middle ground switches the bound game character on the basis of the character switching request.

303. The livestreaming middle ground transmits a push address obtaining request to a livestreaming platform, the push address obtaining request carrying identifiers of the at least two participants.

A push address is an address for pushing a video stream to the livestreaming platform. The livestreaming platform may push the video stream to the same or another livestreaming platform on the basis of the push address. The livestreaming platform is an exemplary description of a livestreaming server capable of providing a livestreaming service to the outside. In some embodiments, the identifier of the participant includes a game account logged in to the livestreaming middle ground by the participant and an identifier of a game character bound to the livestreaming middle ground under the game account.

304. The livestreaming platform generates, in response to the push address obtaining request, at least two push addresses separately corresponding to the at least two participants, and transmits the at least two push addresses to the livestreaming middle ground.

In some embodiments, in response to receiving the push address obtaining request, the livestreaming platform obtains the identities of the at least two participants from the push address obtaining request. The livestreaming platform generates, on the basis of the identifiers of the at least two participants, at least two push addresses separately associated with the at least two participants, and each push address is used for obtaining a video stream of the participant associated with the push address. The livestreaming platform transmits the at least two push addresses to the livestreaming middle ground.

In some embodiments, the livestreaming platform may also transmit, to the livestreaming middle ground, keys separately associated with the at least two push addresses while transmitting the at least two push addresses to the livestreaming middle ground, and the keys are used for verifying the transmitted video streams. When the livestreaming middle ground subsequently pushes the video streams to the livestreaming platform on the basis of the push addresses, the keys associated with the push addresses need to be carried. After receiving the video streams pushed by the livestreaming middle ground, the livestreaming platform verifies the keys carried in the video streams, and will continue to receive the video streams only after the key verification succeeds. If the key verification fails, the livestreaming platform will stop receiving the video streams, to ensure the security of the video streams. In some embodiments, the keys associated with the push addresses are obtained by performing a hash operation on the push addresses, or are obtained by performing other types of encryption operations on the push addresses. This embodiment the disclosure does not limit this.

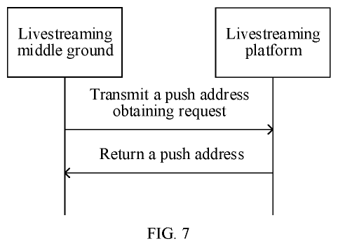

Operation 303 and Operation 304 described above will be described below with reference to FIG. 7.

Referring to FIG. 7, the livestreaming middle ground transmits a push address obtaining request to the livestreaming platform. The push address obtaining request carries game accounts used by at least two participants to log in to the livestreaming middle ground, and identifiers of game characters successfully bound to the livestreaming middle ground under the game accounts used by at least two participants to log in to the livestreaming middle ground. In some embodiments, the livestreaming middle ground may store, in the form of an array, game accounts and identifiers of game characters corresponding to the game accounts. That is, the livestreaming middle ground stores a first game account and an identifier of a game character corresponding to the first game account in a first row of an array, stores a second game account and an identifier of a game character corresponding to the second game account in a second row of the array, and so on, until a first array is obtained. The first array also carries the game accounts used by the at least two participants to log in to the livestreaming middle ground, and the identifiers of the game characters corresponding to the game accounts. After receiving the push address obtaining request, the livestreaming platform obtains the first array from the push address obtaining request. The livestreaming platform generates, on the basis of the first array, push addresses with the same number as that of the game accounts in the first array, and adds the push addresses to corresponding rows in the first array to obtain a second array. Each row of the second array records a game account, an identifier of a game character corresponding to the game account, and a corresponding push address. The livestreaming platform transmits the second array. The second array also carries the push addresses separately corresponding to the game accounts used by the at least two participants to log in to the livestreaming middle ground. The push addresses separately corresponding to the game accounts used by the at least two participants to log in to the livestreaming middle ground are push addresses separately associated with the at least two participants.

In some embodiments, the push address obtaining request transmitted by the livestreaming middle ground to the livestreaming platform also carries an identifier of a target game. The target game is a game corresponding to the target battle. By carrying the identifier of the target game, it is convenient for the livestreaming platform to classify a game according to the type of the game, and it is convenient for audiences to search for livestreaming.

For example, the form of the first array transmitted by the livestreaming middle ground to the livestreaming platform is:
Game Code: 101
Openid: “DFAGS”, Roleid: 123456
Openid: “KIUYT”, Roleid: 23456
Openid: “ARETY”, Roleid: 34567
. . .
where Game Code is the identifier of the target game; Openid is a game account; and Roleid is an identifier of a game character.

The form of the second array transmitted by the livestreaming platform to the livestreaming middle ground is:

Game Code: 101
{″Openid″: ″DFAGS″.
″Roleid″: ″123456″.
″url″: ″www.cdn.xxx.com/123456″},
{″Openid″: ″KIUYT″,
″Roleid″: ″23456″,
″url″: ″www.cdn.xxx.com/23456″},
{″Openid″: ″ARETY″,
″Roleid″: ″34567″,
″url″: ″www.cdn.xxx.com/34567″}
......

where url is a push address.

305. The livestreaming middle ground transmits a data synchronization request to the at least two participants. The data synchronization request is used for obtaining operation information of the at least two participants during the target battle.

The operation information is information that the participants control the virtual objects to perform actions in the virtual scene of the target battle, such as information that the participants control the virtual objects to move in the virtual scene, or information that the participants control the virtual objects to release virtual skills in the virtual scene, or information that the participants control the virtual objects to purchase virtual props in the virtual scene, or information that the participants control the virtual objects to use virtual props in the virtual scene, and the like. This embodiment the disclosure does not limit this. In some embodiments, the operation information of the at least two participants is operation information uploaded to the gaming server by the at least two participants in the target battle. The livestreaming middle ground may obtain the operation information of the at least two participants through the data synchronization request. That is, the at least two participants may also upload the operation information to the livestreaming middle ground while uploading the operation information to the gaming server.

In some embodiments, the livestreaming middle ground transmits a data synchronization request to the at least two participants. The data synchronization request carries an Application Programming Interface (API) corresponding to the livestreaming middle ground, and the participants may upload operation information to the livestreaming middle ground via the API.

In some embodiments, the above operation information refers to control information of the participants to virtual objects in a virtual scene, and the form that the participants transmit the control information to the livestreaming middle ground is:

Game Code: 101
{″Openid″: ″DFAGS″,
″Roleid″: ″123456″.
″data″: {//replay'}
},
{″Openid″: ″KIUYT″,
″Roleid″: ″23456″,
″data″: {//replay}
},
{″Openid″: ″ARETY″.
″Roleid″: ″34567″.
″data″: {//replay'}
}
......

where data is control information.

The above operation 305 may be performed after operation 304 as well as after operation 302, that is, after the livestreaming middle ground binds the at least two participants with the target battle. In some embodiments, the livestreaming middle ground may synchronously perform operation 303 and operation 305 described above after operation 302. This embodiment the disclosure does not limit this. This embodiment the disclosure is described in the order of operation 301 to operation 305.

Operation 306. After receiving the operation information returned by the at least two participants, the livestreaming middle ground transmits the operation information of the at least two participants to the cloud gaming server.

The cloud gaming server has a real-time rendering capability. After the livestreaming middle ground transmits the operation information returned by the at least two participants to the cloud gaming server, the cloud gaming server may render the virtual scene of the target battle on the basis of the operation information of the at least two participants to obtain video streams separately associated with the at least two participants, and each video stream carries a game picture of the participant associated with the video stream.

In some embodiments, long connections are established between the livestreaming middle ground and the at least two participants, respectively, and the at least two participants may transmit the operation information to the livestreaming middle ground in real time via the long connections. Optionally, a long connection is also established between the livestreaming middle ground and the cloud gaming server. The livestreaming middle ground may forward the operation information to the cloud gaming server via the long connection after obtaining the operation information uploaded by the at least two participants.

Through operation 306, the livestreaming middle ground may forward the operation information returned by the at least two participants to the cloud gaming server, and may subsequently perform real-time rendering through the cloud gaming server to generate game pictures.

In some embodiments, before operation 306, the livestreaming middle ground may also transmit a voice stream obtaining request to the at least two participants. The voice stream obtaining request is used for obtaining voice streams of the at least two participants during the running of the target battle.

An example in which the target battle includes 10 participants is taken as an example. The 10 participants are divided into two teams to fight against each other in a virtual scene. In the fighting process, the participants of the same team often communicate by voice. The livestreaming middle ground may obtain voice streams separately associated with the 10 participants by using a voice stream obtaining request. The livestreaming middle ground may subsequently push the voice streams separately associated with the 10 participants to the audience terminal while pushing video streams separately associated with the 10 participants to the audience terminal, so that a user watching the livestreaming may obtain more information, to improve the information obtaining efficiency of the user. In some embodiments, after the livestreaming middle ground obtains the voice streams from at least two participants, the livestreaming middle ground may also push the voice streams to the livestreaming platform, so that the livestreaming platform pushes the voice streams to corresponding audience terminals.

Operation 307. The cloud gaming server receives the operation information of the at least two participants, renders the virtual scene of the target battle on the basis of the operation information of the at least two participants, and obtains at least two video streams separately corresponding to the at least two participants. Each video stream carries a game picture corresponding to a view of the corresponding participant.

Operation 307 described above is equivalent to that the cloud gaming server renders the virtual scene of the target battle on the basis of the operation information of the at least two participants to obtain the at least two video streams separately associated with the at least two participants, and each video stream is used for providing the game picture at the view of the participant associated with the video stream.

Since the methods for rendering the virtual scene by the cloud gaming server on the basis of the operation information of the at least two participants belong to the same technical concept, a process for rendering the virtual scene by the cloud gaming server on the basis of the operation information of one of the at least two participants will be described below.

In some embodiments, after receiving control information of a participant, the cloud gaming server determines, on the basis of the control information, a position, pose and action, in the virtual scene, of the virtual object controlled by the participant. The cloud gaming server determines a view of the virtual object on the basis of the position, pose and action, in the virtual scene, of the virtual object. The view of the virtual object is a view of the participant. The cloud gaming server renders the virtual scene of the target battle on the basis of the view of the virtual object, to obtain a game picture associated with the participant. The game picture is a game picture obtained by rendering based on the control information transmitted by the participant, and a plurality of game pictures of the participant constitute a video stream of the participant. For example, when an operation performed by a user on the virtual object is moving in the virtual scene, the control information of the participant is information used for controlling the virtual object to move in the virtual scene. The cloud gaming server determines, on the basis of the control information, a position, pose and action of the virtual object in the virtual scene after the movement. The cloud gaming server determines a view of the virtual object on the basis of the position, pose and action, in the virtual scene, of the virtual object. The cloud gaming server renders the virtual scene of the target battle on the basis of the view of the virtual object, and obtains a game picture associated with the participant.

In some embodiments, in the process that the cloud gaming server renders the virtual scene of the target battle on the basis of the control information of the virtual object to obtain the game picture associated with the participant, a first participant of the at least two participants is taken as an example for description. A game picture at a view of the first participant refers to a second game picture, and the cloud gaming server may also perform any one of the following processing on the second game picture on the basis of the control information of the virtual object:

In some embodiments, in a case that the control information of the virtual object indicates that a non-directional skill of the virtual object is selected by the participant, the cloud gaming server adds a skill indicator of the non-directional skill in the second game picture. The skill indicator indicates a release direction of the non-directional skill. The non-directional skill is a skill that does not specify a casting target, and the release direction of the non-directional skill is specified by the user.

In this implementation, when the participant selects the non-directional skill of the virtual object, the cloud gaming server may render the skill indicator of the non-directional skill in the second game picture. Since the skill indicator may indicate the release direction of the non-directional skill, the user may know, when watching the second game picture, a direction in which the participant releases the non-directional skill by watching the direction indicated by the skill indicator, thereby improving the information obtaining efficiency of the user.

In some embodiments, in a case that the control information of the virtual object indicates that the participant controls the virtual object to use a directional skill, secondary rendering is performed on an outline of an attack target of the directional skill in the second game picture, so that the action target is highlighted in the second game picture. The directional skill is a skill that specifies an action target.

In this implementation, when the participant selects the directional skill of the virtual object, the cloud gaming server may perform secondary rendering on the action target of the directional skill in the second game picture, to highlight the action target in the second game picture. The user may quickly know the action target of the directional skill when watching the second game picture, so that the human-computer interaction efficiency is relatively high.

In some embodiments, a movement mark is added at a target position in the second game picture in a case that the control information of the virtual object indicates that the participant controls the virtual object to move towards a target position in the second game picture.

In this implementation, when the participant controls the virtual object to move in the virtual scene, the cloud gaming server may add the movement mark at the target position of each movement of the virtual object. The user may know, when watching the second game picture, the target position towards which the virtual object is about to move, thereby improving the information obtaining efficiency of the user.

Through operation 307, the cloud gaming server may render the virtual scene on the basis of the control information of the at least two participants respectively, to obtain the at least two video streams separately associated with the at least two participants. Different video streams are video streams associated with views of different participants. If the participant is a terminal used by a player participating in the target battle, the video stream associated with the participant is a video stream of the virtual scene observed at a view of the virtual object controlled by the player. A content of the video stream associated with the participant is the same as that watched by the player.

308. The cloud gaming server pushes the at least two video streams to the livestreaming middle ground.

In one possible implementation, the cloud gaming server pushes the at least two video streams to the livestreaming middle ground via the long connection with the livestreaming middle ground.

309. After receiving the at least two video streams, the livestreaming middle ground transmits, according to at least two push addresses separately corresponding to the at least two participants, the video streams separately corresponding to the at least two participants to the livestreaming platform.

In one possible implementation, the livestreaming middle ground determines participants separately associated with the at least two video streams after receiving at least two video streams. The livestreaming middle ground transmits the at least two video streams to the livestreaming platform according to at least two push addresses separately associated with the at least two participants. In some embodiments, the livestreaming platform may provide a plurality of livestreaming entries for the target battle, and each livestreaming entry corresponds to the video stream of one participant. The user may select and watch different video streams through different livestreaming entries. Since different video streams correspond to views of different participants of the target battle, the user selects different video streams, namely, selects views of different participants, to watch the target battle.

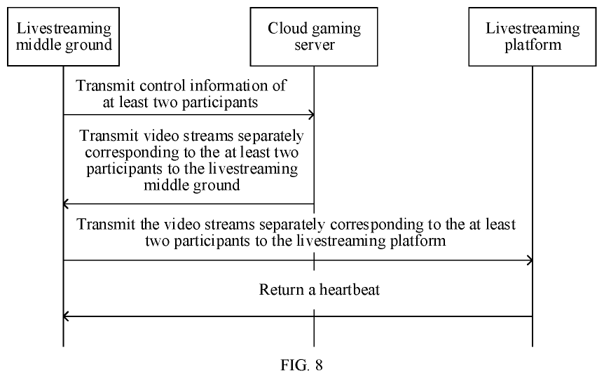

Operation 307 to Operation 309 described above will be described with reference to FIG. 8.

Referring to FIG. 8, the livestreaming middle ground transmits control information of at least two participants to the cloud gaming server. The cloud gaming server renders a virtual scene of a target battle on the basis of the control information of the at least two participants, to obtain video streams separately corresponding to the at least two participants. The cloud gaming server transmits the video streams separately corresponding to the at least two participants to the livestreaming middle ground. After receiving the video streams separately corresponding to the at least two participants, the livestreaming middle ground transmits the video streams separately corresponding to the at least two participants to the livestreaming platform according to at least two push addresses separately corresponding to the at least two participants. The livestreaming platform returns a heartbeat to the livestreaming middle ground after receiving the video streams separately corresponding to the two participants.

310. The livestreaming middle ground obtains a second video stream uploaded by the watcher. The second video stream carries a first game picture; the first game picture is a game picture corresponding to a preset view; and the preset view is a view of the watcher of the target battle.

The second video stream is used for providing the first game picture at the preset view.

The watcher is a terminal used by a game referee or a game commentator. Compared with the participant, the watcher does not directly participate in the battle, that is, the watcher does not control a virtual object in the virtual scene, and the watcher may view any position in the virtual scene. The participant may control the virtual object to fight anywhere in the virtual scene, so that the gaming referee or commentator may view, through the watcher, the position where the virtual object fights in the virtual scene. The watcher obtains relevant data of the target battle from the gaming server, and renders the virtual scene on the basis of the obtained data, to obtain the first game picture. The first game picture is a game picture displayed on the watcher. In some embodiments, a game data panel is displayed in the first game picture, and a virtual prop, virtual currency and the like that each participant owns in the virtual scene are displayed in the game data panel. An overall situation of the target battle may be quickly learned by viewing the game data panel.

In one possible implementation, a long connection is established between the watcher and the livestreaming middle ground, and the watcher may obtain relevant data of the target battle in real time from a gaming platform. The watcher performs rendering on the basis of the obtained data, to obtain the first game picture. Correspondingly, the long connection is established between the watcher and the livestreaming middle ground, so that the watcher may transmit a second video stream carrying the first game picture to the livestreaming middle ground via the long connection. In some embodiments, a long connection between the watcher and the livestreaming middle ground is established before the target battle starts. In response to the start of the target battle, the watcher may transmit the second video stream to the livestreaming middle ground via the long connection.

Operation 310 described above may be performed before operation 305. In some embodiments, the livestreaming middle ground may obtain the second video stream uploaded by the watcher while obtaining the video streams corresponding to the at least two participants.

Operation 311. The livestreaming middle ground transmits the second video stream to the livestreaming platform.

In one possible implementation, the livestreaming middle ground transmits the second video stream to the livestreaming platform on the basis of a push address associated with the watcher.

In some embodiments, the watcher may also bind a game account that watches the target battle with the livestreaming middle ground. The binding process belongs to the same technical concept as that of the method for binding a game account with the livestreaming middle ground by a participant. The implementation process refers to operation 301 and operation 302 described above, and will not be described in detail herein. After the watcher binds the game account that watches the target battle with the livestreaming middle ground, the livestreaming middle ground may also obtain the push address associated with the watcher from the livestreaming platform. The implementation process belongs to the same technical concept as that of the method for obtaining a push address corresponding to a participant by the livestreaming middle ground. The implementation process refers to operation 303 and 304 described above, and will not be described in detail herein.

312. The livestreaming platform receives the second video stream, and transmits the second video stream to an audience terminal.

In one possible implementation, a long connection is established between the livestreaming platform and the audience terminal. The livestreaming platform pushes the second video stream to the audience terminal via the long connection, namely, pushes the video stream associated with the watcher of the target battle to the audience terminal. In some embodiments, the second video stream is a video stream pushed by the livestreaming platform to the watcher by default. That is, after the audience terminal enters a livestreaming room of the target battle, the livestreaming platform directly pushes the second video stream to the audience terminal. This is because the second video stream is a video stream associated with the watcher of the target battle, and the watcher of the target battle is a referee or commentator of the target battle. Watching the target battle at the view of the referee or commentator of the target battle may obtain rich information. In some embodiments, the view of the watcher is also referred to as a “global view” or “god view” through which the position of each virtual object in the virtual scene may be seen.

The audience terminal receives the second video stream and displays the first game picture in the livestreaming page of the target battle on the basis of the second video stream.

In one possible implementation, after receiving the second video stream, the audience terminal decodes the second video stream to obtain a plurality of first game pictures provided by the second video stream. The audience terminal displays the first game pictures in a livestreaming page of the target battle. The livestreaming page is an exemplary description of a livestreaming interface. The livestreaming interface includes a web page for displaying a livestreaming video stream in a browser application program, and also includes a UI interface for displaying a livestreaming video stream in a livestreaming application program. This embodiment the disclosure does not make specific restrictions on the type of the livestreaming interface.

314. The audience terminal determines a first participant in response to a first operation performed on a view switching control displayed on the livestreaming page, the first participant being a participant, corresponding to the first operation, among the at least two participants, and the view switching control being used for performing switching to display game pictures corresponding to views of different participants.

In operation 314 described above, namely, in one possible implementation that the audience terminal determines the first participant in response to the first operation performed on the view switching control displayed on the livestreaming interface, the audience terminal is a terminal that accesses a livestreaming service provided by the livestreaming server.

In some embodiments, the audience terminal displays a view selection region on the livestreaming page in response to a click operation performed on the view switching control displayed on the livestreaming page, and identifiers of the at least two participants are displayed in the view selection region. The audience terminal determines, in response to a click operation performed on any one of the identifiers of the at least two participants, a participant associated with the identifier as the first participant.

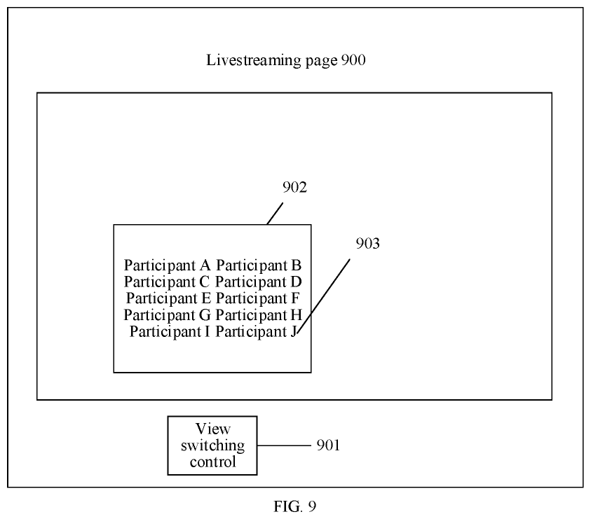

For example, referring to FIG. 9, the audience terminal displays a livestreaming page 900. A view switching control 901 displayed in the livestreaming page 900. The audience terminal displays a view selection region 902 in the livestreaming page 900 in response to a click operation performed on the view switching control 901. Identifiers of at least two participants are displayed in the view selection region 902. The audience terminal determines, in response to a click operation performed on any one of the identifiers 903 of the at least two participants, a participant associated with the identifier 903 as the first participant.

315. The audience terminal obtains a first video stream corresponding to the first participant from the livestreaming platform, the first video stream being a video stream obtained after the cloud gaming server renders, on the basis of operation information of the first participant, a virtual scene of the target battle, and the first video stream being used for providing the second game picture.

In some embodiments, the audience terminal transmits a video stream obtaining request to the livestreaming platform. The video stream obtaining request carries the identifier of the first participant. After obtaining the video stream obtaining request, the livestreaming platform obtains the identifier of the first participant from the video stream obtaining request, and determines, on the basis of the identifier of the first participant, a first video stream associated with the first participant from at least two video streams. The livestreaming platform transmits the first video stream associated with the first participant to the audience terminal. The audience terminal obtains the first video stream associated with the first participant. The first video stream is a video stream, associated with the first participant, among at least two video streams pushed by the livestreaming middle ground to the livestreaming platform, and the first video stream is used for providing the second game picture.

In some embodiments, the audience terminal obtains a first video stream associated with the first participant and a voice stream associated with the first participant from the livestreaming platform. The voice stream of the first participant is obtained by the livestreaming middle ground in operation 306 above. After obtaining the first video stream associated with the first participant and the voice stream associated with the first participant, the audience terminal may play the voice stream while playing the first video stream, so that the user watching the livestreaming may watch the video stream and hear the voice stream, thereby improving the information obtaining efficiency of the user.

For example, the audience terminal transmits a video stream obtaining request to the livestreaming platform. The video stream obtaining request carries the identifier of the first participant. After obtaining the video stream obtaining request, the livestreaming platform obtains the identifier of the first participant from the video stream obtaining request, determines, on the basis of the identifier of the first participant, a first video stream associated with the first participant from at least two video streams, and determines, on the basis of the identifier of the first participant, a voice stream associated of the first participant from at least two voice streams. The livestreaming platform transmits the first video stream associated with the first participant and the voice stream associated with the first participant to the audience terminal. The audience terminal obtains the first video stream associated with the first participant and the voice stream associated with the first participant.

316. The audience terminal displays the second game picture of the target battle on the livestreaming page on the basis of the first video stream.

In some embodiments, after obtaining the first video stream, the audience terminal decodes the first video stream to obtain a plurality of second game pictures provided by the first video stream. The audience terminal displays the second game picture in the livestreaming page of the target battle.

In some embodiments, if the audience terminal obtains a first video stream and a voice stream associated with the first participant, the audience terminal plays the voice stream while displaying the second game picture of the target battle on the livestreaming page.

In this implementation, the user may also hear voices of the first participant during the running of the target battle while watching the second game picture. The user may know a communication status of a user using the first participant with other participants, which improves the information obtaining efficiency of the user.

In some embodiments, the audience terminal switches the first game picture to the second game picture on the livestreaming page.

In this implementation, the audience terminal displays the second game picture in a replacement manner, that is, the audience terminal replaces the first game picture displayed on the livestreaming page with the second game picture. Since the second game picture is a game picture corresponding to the first participant of the target battle, it may be ensured that the user focuses on watching the target battle at the view of the first participant when watching the livestreaming.

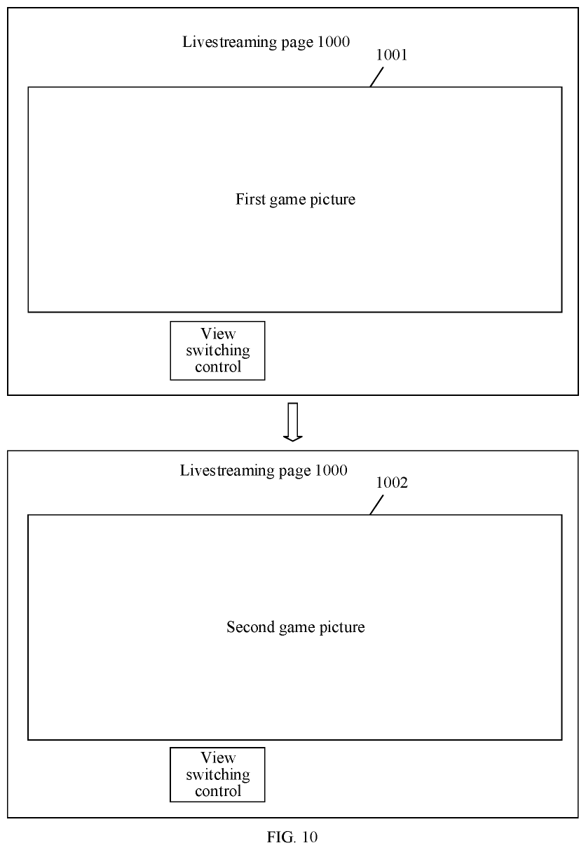

For example, referring to FIG. 10, the audience terminal displays a first game picture 1001 in a livestreaming page 1000. After receiving a first video stream, the audience terminal switches the first game picture 1001 displayed in the livestreaming page 1000 to a second game picture 1002 on the basis of the first video stream.

In some embodiments, the audience terminal simultaneously displays the first game picture and the second game picture on the livestreaming page.

In this implementation, the audience terminal may simultaneously display the first game picture and the second game picture on the livestreaming page. The first game picture is the game picture corresponding to the view of the watcher of a target battle, and the second game picture is the game picture corresponding to the view of the first participant of the target battle, so that the user may learn about global information of the target battle while watching the first game picture, and may learn about local information of the view of the first participant of the target battle while watching the second game picture. This display manner of global information plus local information helps the user obtain more information in the same livestreaming page.

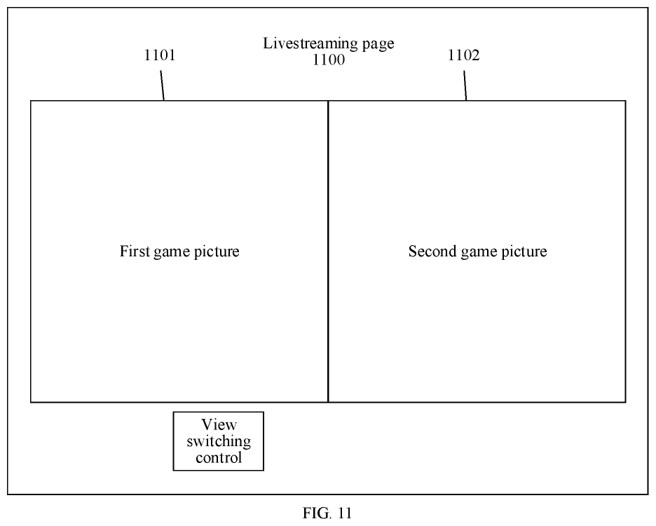

For example, the audience terminal obtains the first video stream and the second video stream simultaneously from the livestreaming platform, and the audience terminal decodes the first video stream and the second video stream respectively, to obtain the first game picture and the second game picture. The audience terminal displays the first game picture at a first position of the livestreaming page and displays the second game picture at a second position of the livestreaming page. The first position and the second position are configured by a person skilled in the art according to an actual situation. For example, the first position is configured on the left side of the livestreaming page, and the second position is configured on the right side of the livestreaming page. This embodiment the disclosure does not limit this. Optionally, the first position and the second position may also be configured by the user. For example, referring to FIG. 11, the audience terminal displays a first game picture 1101 and a second game picture 1102 on a livestreaming page 1100.

In some embodiments, after displaying the first game picture and the second game picture on the livestreaming page, the audience terminal displays, in response to a dragging operation performed on the first game picture, the first game picture at a position where the dragging operation ends, and the audience terminal displays, in response to a dragging operation performed on the second game picture, the second game picture at a position where the dragging operation ends. The user may adjust display positions of the first game picture and the second game picture in the livestreaming page through the dragging operation, to achieve personalized setting of the livestreaming page.

In one possible implementation, in a case that a non-directional skill of the first virtual object is selected by the first participant, the audience terminal displays a skill indicator of the non-directional skill in the second game picture. The skill indicator indicates a release direction of the non-directional skill.

For the above implementation, adding the skill indicator of the non-directional skill to the second game picture may be completed by the cloud gaming server during the rendering of the second game picture. This manner refers to the relevant description of operation 307 described above, and will not be described in detail herein. If the skill indicator of the non-directional skill is added in the second game picture by the cloud gaming server, the audience terminal may directly display the second game picture that includes the skill indicator of the non-directional skill.

In some embodiments, adding the skill indicator of the non-directional skill in the second game picture is completed by the audience terminal. That is, the audience terminal obtains control information of the first participant from the livestreaming platform while obtaining the first video stream from the livestreaming platform. The control information of the first participant is transmitted by the livestreaming middle ground to the livestreaming platform. After receiving the first video stream and the control information of the first participant, the audience terminal may decode the first video stream to obtain the second game picture. In a case that the control information of the virtual object indicates that the non-directional skill of the virtual object is selected by the participant, the audience terminal adds a skill indicator of the non-directional skill in the second game picture. A user may learn about the release direction of the non-directional skill of the user using the first participant by viewing the skill indicator of the non-directional skill in the second game picture, thereby increasing the information amount obtained by the user from the livestreaming page.

In some embodiments, the audience terminal highlights an action target of the directional skill in the second game picture in a case that the first participant controls the first virtual object to use a directional skill.

For the above implementation, highlighting the action target of the directional skill in the second game picture may be completed by the cloud gaming server during the rendering of the second game picture. This manner refers to the relevant description of operation 307 described above, and will not be described in detail herein. If highlighting the action target of the directional skill is completed by the cloud gaming server, the audience terminal may directly display the second game picture, and the action target of the directional skill in the second game picture is highlighted.

In some embodiments, highlighting the action target of the directional skill in the second game picture is completed by the audience terminal. That is, the audience terminal obtains control information of the first participant from the livestreaming platform while obtaining the first video stream from the livestreaming platform. The control information of the first participant is transmitted by the livestreaming middle ground to the livestreaming platform. After receiving the first video stream and the control information of the first participant, the audience terminal may decode the first video stream to obtain the second game picture. The audience terminal highlights an action target of the directional skill in the second game picture in a case that the control information of the first virtual object indicates that the participant controls the first virtual object to use a directional skill. A user may learn about the action target of the directional skill of the user using the first participant by viewing the action target highlighted in the second game picture, thereby increasing the information amount obtained by the user from the livestreaming page.

In one possible implementation, the audience terminal displays a movement mark at the target position in the second game picture in a case that the first participant controls the first virtual object to move towards a target position in the second game picture.

For the above implementation, adding the movement mark at the target position in the second game picture may be completed by the cloud gaming server during the rendering of the second game picture. This manner refers to the relevant description of operation 307 described above, and will not be described in detail herein. If the movement mark is added at the target position in the second game picture by the cloud gaming server, the audience terminal may directly display the second game picture that includes the movement mark.

In some embodiments, adding the movement mark at the target position in the second game picture is completed by the audience terminal. That is, the audience terminal obtains control information of the first participant from the livestreaming platform while obtaining the first video stream from the livestreaming platform. The control information of the first participant is transmitted by the livestreaming middle ground to the livestreaming platform. After receiving the first video stream and the control information of the first participant, the audience terminal may decode the first video stream to obtain the second game picture. A movement mark is added at a target position in the second game picture in response to that the control information of the first virtual object indicates that the participant controls the first virtual object to move towards a target position in the second game picture. By viewing the movement mark in the second game picture, a user may learn about a position towards which the first virtual object is about to move, thereby increasing the information amount obtained by the user from the livestreaming page.

317. The audience terminal determines a second participant in response to a second operation performed on the view switching control, the second participant being a participant, corresponding to the second operation, among the at least two participants.

The process of determining the second participant by the audience terminal belongs to the same technical concept as the process of determining the first participant by the audience terminal, and the implementation process refers to the relevant description of operation 314 described above, which will not be described in detail herein.

318. The audience terminal displays a third game picture of the target battle on the livestreaming page, the third game picture being a game picture corresponding to a reference view, and the reference view being a view of the second participant of the target battle.

In one possible implementation, the audience terminal receives a third video stream and displays the third game picture in the livestreaming page of the target battle on the basis of the third video stream.

All the above optional technical solutions may be used in any combination to form the optional embodiments the disclosure, which will not be described in detail herein.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

In the embodiments the disclosure, the cloud gaming is used. That is, the cloud gaming server is used to render a virtual scene on the basis of control information of different participants, to obtain game pictures separately associated with the different participants, and to provide audiences of livestreaming platform with an immersion competition watching experience solution in which watching views may be freely selected.

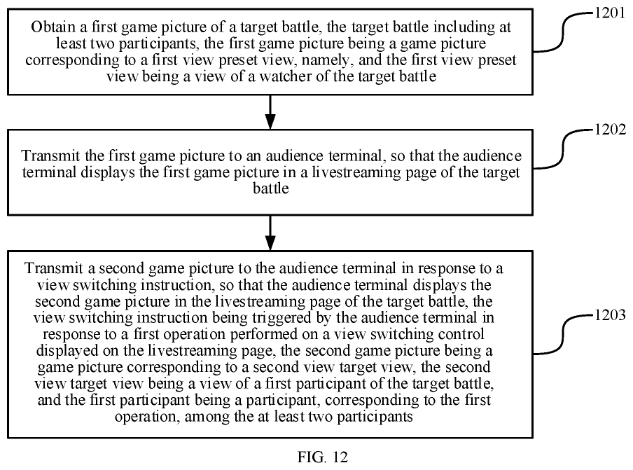

The embodiments the disclosure further provide a game picture display method taking a livestreaming middle ground, namely, a livestreaming control server, as an executive body. Referring to FIG. 12, the method includes:

1201. Obtain a first game picture of a target battle, the target battle including at least two participants, the first game picture being a game picture corresponding a preset view, namely, the first game picture being a game picture at the preset view, and the preset view being a view of a watcher of the target battle.

1202. Transmit the first game picture to an audience terminal, so that the audience terminal displays the first game picture in a livestreaming page of the target battle, the audience terminal being an exemplary description of a terminal watching the target battle, and the livestreaming page being an exemplary description of a livestreaming interface displayed on the terminal.

1203. Transmit a second game picture to the audience terminal in response to a view switching instruction, so that the audience terminal displays the second game picture in the livestreaming page of the target battle, the view switching instruction being triggered by the audience terminal in response to a first operation performed on a view switching control displayed on the livestreaming page, that is, the view switching instruction being triggered by the terminal in response to the first operation performed on the view switching control displayed on the livestreaming interface, the second game picture being a game picture corresponding to a target view, that is, the second game picture being a game picture at the target view, the target view being a view of the first participant of the target battle, and the first participant being a participant, corresponding to the first operation, among the at least two participants. In other words, the first participant is a participant, associated with the first operation, among the at least two participants.

The implementation process of the game picture display method taking the livestreaming middle ground, namely, the livestreaming control server, as the executive body refers to the relevant description of operation 301 to operation 318 described above, and will not be described in detail herein.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

In the above descriptions, the audience terminal, the livestreaming platform, the livestreaming middle ground, the participant, the watcher, the gaming server and the cloud gaming server form a game picture display system. The implementation environment of the game picture display method is described in FIG. 1 where functions of the various components are briefly described. The game picture display system will be described below in conjunction with the above-mentioned method embodiments. Referring to FIG. 1, the system includes:
at least two participants of a target battle, a livestreaming middle ground, a livestreaming platform and an audience terminal of the livestreaming platform. The participants refer to gaming terminals participating in the target battle. The livestreaming middle ground refers to a livestreaming control server configured to provide game pictures at views of different participants and a view of a watcher. The livestreaming platform refers to a livestreaming server configured to provide a livestreaming service. The audience terminal refers to an audience terminal watching the target battle.

The livestreaming middle ground is configured to obtain a first game picture of a target battle, the target battle including at least two participants, the first game picture being a game picture corresponding to a preset view, and the preset view being a view of a watcher of the target battle.

The livestreaming middle ground is further configured to transmit the first game picture to the livestreaming platform, and the livestreaming platform transmits the first game picture to the audience terminal.

The audience terminal is configured to: receive the first game picture, and display the first game picture in a livestreaming page of the target battle. The livestreaming page is an exemplary description of a livestreaming interface displayed in the audience terminal.

The audience terminal is further configured to transmit a view switching instruction to the livestreaming middle ground in response to a first operation performed on a view switching control displayed on the livestreaming page, the view switching instruction being used for performing switching to display a second game picture corresponding to a target view, the target view being a view of a first participant of the target battle, and the first participant being a participant, corresponding to the first operation, among the at least two participant.

The livestreaming middle ground is further configured to transmit the second game picture to the audience terminal in response to receiving the view switching instruction.

The audience terminal is further configured to: receive the second game picture, and display the second game picture in the livestreaming page of the target battle.

In some embodiments, the livestreaming middle ground is further configured to: obtain operation information of the at least two participants, and transmit the operation information of the at least two participants to the cloud gaming server. The cloud gaming server is configured to: receive the operation information of the at least two participants, render a virtual scene of the target battle on the basis of the operation information of the at least two participants, and obtain game pictures separately corresponding to the at least two participants.

In some embodiments, the livestreaming middle ground is further configured to obtain a first video stream corresponding to the first participant from the cloud gaming server, the first video stream being a video stream obtained after the cloud gaming server renders the virtual scene of the target battle on the basis of the operation information of the first participant, and the first video stream carrying the second game picture, namely, the first video stream being used for providing the second game picture. The livestreaming middle ground is further configured to transmit the first video stream to the audience terminal in response to the view switching instruction.

In some embodiments, the livestreaming middle ground is further configured to obtain a second video stream uploaded by the watcher, the second video stream carrying the first game picture. The livestreaming middle ground is further configured to transmit the second video stream to the audience terminal. The audience terminal is further configured to receive the second video stream and display the first game picture of the target battle in the livestreaming page of the target battle on the basis of the second video stream.

In some embodiments, the livestreaming middle ground is further configured to transmit a push address obtaining request to the livestreaming platform, the push address obtaining request carrying identifiers of the at least two participants. The livestreaming platform is further configured to: generate at least two push addresses separately associated with the at least two participants in response to the push address obtaining request, and transmit the at least two push addresses to the livestreaming middle ground. The livestreaming middle ground is further configured to push the game pictures separately associated with the at least two participants to the livestreaming platform according to the at least two push addresses separately associated with the at least two participants, and the livestreaming platform transmits the game pictures separately associated with the at least two participants to the audience terminal.

In some embodiments, the at least two participants are used for transmitting account binding requests to the livestreaming middle ground, the account binding request carrying game accounts of the at least two participants. The livestreaming middle ground is further configured to: receive the account binding requests of the at least two participants, and bind the game accounts of the at least two participants with the target battle.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

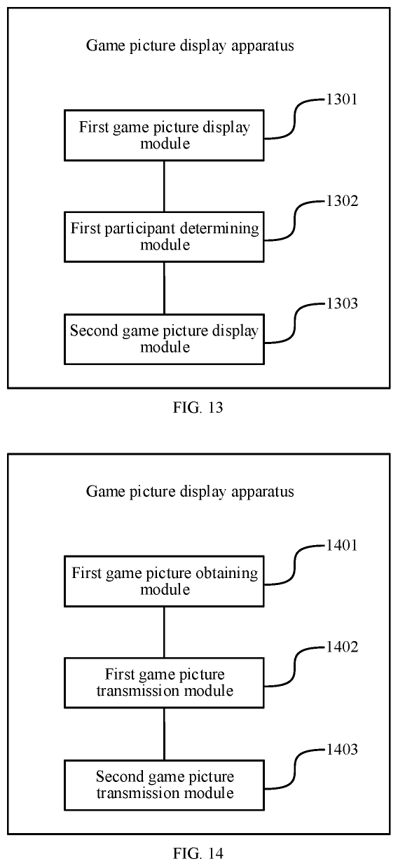

FIG. 13 is a schematic structural diagram of a game picture display apparatus provided according to an embodiment the disclosure. Referring to FIG. 13, the apparatus includes: a first game picture display module 1301, a first participant determining module 1302 and a second game picture display module 1303.

The first game picture display module 1301 is configured to display a first game picture of the target battle in a livestreaming page of a target battle, the target battle including at least two participants, the first game picture being a game picture corresponding to a preset view, and the preset view being a view of a watcher of the target battle. That is, a first game picture display module 1301 is configured to display a first game picture in a livestreaming interface of a target battle, the target battle including at least two participants, the first game picture being a game picture at a preset view, and the preset view being a view of a watcher of the target battle.

The first participant determining module 1302 is configured to: determine a first participant in response to a first operation performed on a view switching control displayed on the livestreaming page, the first participant being a participant, corresponding to the first operation, among the at least two participants, and the view switching control being used for performing switching to display game pictures corresponding to views of different participants. That is, the first participant determining module 1302 is configured to: determine a first participant in response to a first operation performed on a view switching control displayed on the livestreaming interface, the first participant being a participant, corresponding to the first operation, among the at least two participants.

The second game picture display module 1303 is configured to display a second game picture of the target battle on the livestreaming page, the second game picture being a game picture corresponding to a target view, and the target view being a view of the first participant of the target battle. That is, the second game picture display module 1303 is configured to display a second game picture on the livestreaming interface, the second game picture being a game picture at a target view, and the target view being a view of the first participant of the target battle.

In some embodiments, the first participant determining module 1302 is configured to: display a view selection region on the livestreaming page in response to a click operation performed on the view switching control displayed on the livestreaming page, identifiers of the at least two participants being displayed in the view selection region; and determine, in response to a click operation performed on any one of the identifiers of the at least two participants, the participant corresponding to the identifier as the first participant. In other words, the first participant determining module 1302 is configured to: display a view selection region on the livestreaming interface in response to a click operation performed on the view switching control displayed on the livestreaming interface, identifiers of the at least two participants being displayed in the view selection region; and determine, in response to a click operation performed on any one of the identifiers of the at least two participants, the participant associated with the identifier as the first participant.

In some embodiments, the apparatus further includes:
a first video stream obtaining module, configured to obtain a first video stream associated with the first participant from a livestreaming platform, the first video stream being a video stream obtained after a cloud gaming server renders a virtual scene of the target battle on the basis of operation information of the first participant, and the first video stream being used for providing the second game picture; and that is, the first video stream obtaining module being configured to obtain a first video stream associated with the first participant from a livestreaming server, the first video stream being a video stream obtained after a cloud gaming server renders a virtual scene of the target battle on the basis of operation information of the first participant, and the first video stream being used for providing the second game picture.

The second game picture display module 1303 is further configured to display the second game picture of the target battle on the livestreaming page on the basis of the first video stream. That is, the second game picture display module 1303 is further configured to display the second game picture on the livestreaming interface on the basis of the first video stream.

In some embodiments, the apparatus further includes:
a first video stream obtaining module, configured to obtain a first video stream associated with the first participant and a voice stream associated with the first participant from a livestreaming platform. That is, the first video stream obtaining module Is configured to obtain a first video stream associated with the first participant and a voice stream associated with the first participant from a livestreaming server, the first video stream being a video stream obtained after a cloud gaming server renders a virtual scene of the target battle on the basis of operation information of the first participant, and the first video stream being used for providing the second game picture.

The second game picture display module 1303 is further configured to: display the second game picture of the target battle on the livestreaming page on, and play the voice stream. That is, the second game picture display module 1303 is further configured to: display the second game picture on the livestreaming interface on the basis of the first video stream; and play the voice stream.

In some embodiments, the first game picture includes a first virtual object controlled by the first participant. The second game picture display module 1303 is further configured to perform any of the following: displaying a skill indicator of the non-directional skill in the second game picture in a case that a non-directional skill of the first virtual object is selected by the first participant, the skill indicator being used for indicating a release direction of the non-directional skill; or, highlighting an action target of the directional skill in the second game picture in a case that the first participant controls the first virtual object to use a directional skill; displaying a movement mark at a target position in the second game picture in a case that the first participant controls the first virtual object to move towards a target position in the second game picture.

In some embodiments, the apparatus further includes:
a second participant determining module, configured to determine a second participant in response to a second operation performed on the view switching control, the second participant being a participant, corresponding to the second operation, among the at least two participants, that is, the second participant being a participant, associated with the second operation, among the at least two participants; and
a third game picture display module, configured to display a third game picture of the target battle on the livestreaming page, the third game picture being a game picture corresponding to a reference view, and the reference view being a view of the second participant of the target battle, that is, the third game picture display module being configured to display a third game picture on the livestreaming interface, and the third game picture being a game picture at the reference view.

In some embodiments, the first game picture display module 1301 is configured to: obtain a second video stream uploaded by the watcher, the second video stream carrying the first game picture corresponding to the watcher, that is, the second video stream being used for providing the first game picture; and display the first game picture of the target battle on the livestreaming page of the target battle on the basis of the second video stream, that is, display the first game picture in the livestreaming interface on the basis of the second video stream.

In some embodiments, the second game picture display module 1303 is configured to perform any of the following: switching the first game picture to the second game picture on the livestreaming page, that is, switching the first game picture to the second game picture on the livestreaming interface; or, simultaneously displaying the first game picture and the second game picture on the livestreaming page, that is, displaying the first game picture and the second game picture on the livestreaming interface.

The game picture display apparatus provided in the above embodiment is only exemplified by division of all the above functional modules during the displaying of the game pictures. In practical applications, the above function division may be completed by different functional modules according to a need. That is, internal structures of a computer are divided into different functional modules, to complete all or partial functions described above. In addition, the game picture display apparatus provided in the above embodiment and the game picture display method embodiment belong to the same concept, and details of its specific implementation process are found in the method embodiment, and will not be described herein again.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

FIG. 14 is a schematic structural diagram of a game picture display apparatus provided according to an embodiment the disclosure. Referring to FIG. 14, the apparatus includes: a first game picture obtaining module 1401, a first game picture transmission module 1402 and a second game picture transmission module 1403.

The first game picture obtaining module 1401 is configured to obtain a first game picture of a target battle, the target battle including at least two participants, the first game picture being a game picture corresponding to a preset view, and the preset view being a view of a watcher of the target battle. That is, the first game picture obtaining module 1401 is configured to obtain a first game picture of a target battle, the target battle including at least two participants, the first game picture being a game picture at a preset view, and the preset view being a view of a watcher of the target battle.

The first game picture transmission module 1402 is configured to: transmit the first game picture to an audience terminal, so that the audience terminal displays the first game picture in a livestreaming page of the target battle. That is, the first game picture transmission module 1402 is configured to: transmit the first game picture to a terminal, so that the terminal displays the first game picture in a livestreaming interface of the target battle.

The second game picture transmission module 1403 is configured to transmit a second game picture to the audience terminal in response to a view switching instruction, so that the audience terminal displays the second game picture in the livestreaming page of the target battle, the view switching instruction being triggered by the audience terminal in response to a first operation performed on a view switching control displayed on the livestreaming page, the second game picture being a game picture corresponding to a target view, the target view being a view of the first participant of the target battle, and the first participant being a participant, corresponding to the first operation, among the at least two participants. That is, the second game picture transmission module 1403 is configured to: transmit a second game picture to the terminal in response to a view switching instruction, so that the terminal displays the second game picture in the livestreaming interface of the target battle, the view switching instruction being triggered by the terminal in response to a first operation performed on a view switching control displayed on the livestreaming interface, the second game picture being a game picture at a target view, the target view being a view of the first participant of the target battle, and the first participant being a participant, associated with the first operation, among the at least two participants.

In one possible implementation, the apparatus further includes:
a second video stream obtaining module, configured to obtain a first video stream associated with the first participant from a cloud gaming server, the first video stream being a video stream obtained after the cloud gaming server renders a virtual scene of the target battle on the basis of operation information of the first participant, and the first video stream carrying the second game picture, namely, the first video stream being used for providing the second game picture.

The second game picture transmission module 1403 is configured to transmit the first video stream to the audience terminal in response to a view switching instruction, the audience terminal referring to a terminal watching the target battle.

In one possible implementation, the apparatus further includes: an operation information obtaining module, configured to: obtain operation information of the at least two participants, and transmit the operation information of the at least two participants to the cloud gaming server, so that the cloud gaming server renders the virtual scene of the target battle on the basis of the operation information of the at least two participants.

In one possible implementation, the apparatus further includes: a push address obtaining module, configured to obtain push addresses of the at least two participants from a livestreaming platform, namely, a push address obtaining module being configured to obtain push addresses of the at least two participants from a livestreaming server.

The second game picture transmission module 1403 is configured to transmit the second game picture to the livestreaming platform in response to a view switching instruction according to the push address corresponding to the first participant, and the livestreaming platform transmits the second game picture to the audience terminal. The livestreaming platform is an exemplary description of a livestreaming server configured to provide a livestreaming service for the audience terminal.

In one possible implementation, the apparatus further includes: an account binding module, configured to: obtain account binding requests of the at least two participants, the account binding requests carrying game accounts of the at least two participants; and bind the game accounts of the at least two participants with the target battle.

In one possible implementation, the first game picture obtaining module 1401 is configured to obtain a second video stream uploaded by the watcher, the second video stream carrying the first game picture. The action of transmitting the first game picture to the audience terminal includes: transmitting the second video stream to the audience terminal, so that the audience terminal displays the first game picture of the target battle in the livestreaming page of the target battle on the basis of the second video stream.

The game picture display apparatus provided in the above embodiment is only exemplified by division of all the above functional modules during the displaying of the game pictures. In practical applications, the above function division may be completed by different functional modules according to a need. That is, internal structures of a computer are divided into different functional modules, to complete all or partial functions described above. In addition, the game picture display apparatus provided in the above embodiment and the game picture display method embodiment belong to the same concept, and details of its specific implementation process are found in the method embodiment, and will not be described herein again.

By means of the technical solutions provided by the embodiments the disclosure, in a game livestreaming process, a terminal may display a first game picture in a view of a watcher of a game. Contents in the first game picture are controlled by the watcher. A user watches a virtual scene of the game in the view of the watcher when watching the first game picture. When the user intends to watch the virtual scene of the game in a view of a participant of the game, a first operation is performed on a view switching control to control the terminal to display a second game picture. The second game picture is a game picture of a first participant associated with the first operation. The user watches the virtual scene of the game in a view of the first participant when watching the second game picture, thereby improving the information amount carried in a game picture in a livestreaming process. Therefore, a livestreaming picture supports various game picture watching manners at different views, and the human-computer interaction efficiency is improved.

The embodiments the disclosure provide a computer device, configured to perform the above game picture display method. The computer device is provided as an audience terminal, namely, a terminal, or a livestreaming middle ground, namely, a livestreaming control server. Structures of the audience terminal is first described as follows:

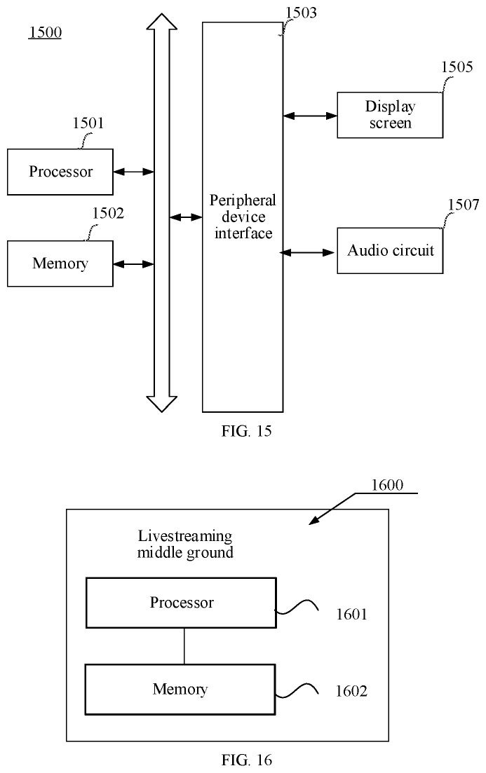

FIG. 15 is a schematic structural diagram of an audience terminal according to an embodiment the disclosure. The audience terminal 1500 includes: a smart phone, a tablet computer, a notebook computer, a desktop computer, and the like. The audience terminal 1500 may also be referred to as a user equipment, a portable audience terminal, a laptop audience terminal, a desktop audience terminal, or other names.

Usually, the audience terminal 1500 includes: one or more processors 1501 and one or more memories 1502.

The processor 1501 includes one or more processing cores, for example, a 4-core processor or an 8-core processor. The processor 1501 is implemented in at least one hardware form of Digital Signal Processing (DSP), a Field-Programmable Gate Array (FPGA), a Programmable Logic Array (PLA). Optionally, the processor 1501 includes a main processor and a coprocessor. The main processor is a processor configured to process data in an awake state, and is also referred to as a central processing unit (CPU). The coprocessor is a low power consumption processor configured to process the data in a standby state. In some embodiments, the processor 1501 is integrated with a graphics processing unit (GPU). The GPU is configured to render and draw content that needs to be displayed on a display screen. In some embodiments, the processor 1501 further includes an artificial intelligence (AI) processor. The AI processor is configured to process computing operations related to machine learning.

The memory 1502 includes one or more non-transitory computer-readable storage media. Optionally, the memory 1502 also includes a high speed random access memory, and a non-volatile memory, such as one or more magnetic disk storage devices and flash storage devices. In some embodiments, the non-transitory computer-readable storage medium in the memory 1502 is configured to store at least one computer program, the at least one computer program being used for being executed by the processor 1501 to implement the game picture display methods provided in the method embodiments the disclosure.

In some embodiments, the audience terminal 1500 also optionally includes: a peripheral interface 1503 and at least one peripheral. The processor 1501, the memory 1502, and the peripheral interface 1503 are connected through a bus or a signal cable. Each peripheral is connected to the peripheral interface 1503 through a bus, a signal cable, or a circuit board. Specifically, the peripheral includes: a display screen 1505 and an audio circuit 1507.

The peripheral interface 1503 may be configured to connect the at least one peripheral related to input/output (I/O) to the processor 1501 and the memory 1502. In some embodiments, the processor 1501, the memory 1502 and the peripheral interface 1503 are integrated on the same chip or circuit board. In some other embodiments, any one or two of the processors 1501, the memory 1502 and the peripheral device interface 1503 are implemented on a single chip or circuit board. This embodiment does not limit this.

The display screen 1505 is configured to display a user interface (UI). The UI includes graphics, texts, icons, videos, and any combination thereof. When the display screen 1505 is a touch display screen, the display screen 1505 also has a capability of acquiring touch signals at or above a surface of the display screen 1505. The touch signal is inputted as a control signal to processor 1501 for processing. At this time, the display screen 1505 is also configured to provide virtual buttons and/or virtual keyboards, also referred to as soft buttons and/or soft keyboards.

The audio circuit 1507 includes a microphone and a speaker. The microphone is used for acquiring sound waves from a user and an environment and converting the sound waves into electrical signals for inputting to the processor 1501 for processing or to a radio frequency circuit for voice communication.

Those skilled in the art will appreciate that the structure shown in FIG. 15 is not intended to be limit the audience terminal 1500. The audience terminal 1500 may include more or fewer components than shown, or combine some components, or adopt a different arrangement of components.

The above computer device may also be provided as a livestreaming middle ground, namely, a livestreaming control server. Structures of the livestreaming middle ground is described as follows:

FIG. 16 is a schematic structural diagram of a livestreaming middle ground provided according to an embodiment the disclosure. The livestreaming middle ground 1600 may vary a lot due to different configurations or performances. The livestreaming middle ground 1600 includes one or more CPUs 1601 and one or more memories 1602. The one or more memories 1602 store at least one computer program, and the at least one computer program is loaded and executed by the one or more CPUs 1601 to implement the methods provided in all the above method embodiments. Optionally, the livestreaming middle ground 1600 also includes components such as a wired or wireless network interface, a keyboard and an input/output interface, to facilitate inputting and outputting. The livestreaming middle ground 1600 further includes other components for realizing the functions of the device, which will not be described in detail herein.

In an exemplary embodiment, a computer-readable storage medium is further provided, for example, a memory including a computer program. The computer program may be executed by a processor to implement the game picture display methods in the above embodiments. For example, the computer-readable storage medium is a read-only memory (ROM), a random access memory (RAM), a compact disc read-only memory (CD-ROM), a magnetic tape, a floppy disk, an optical data storage device, and the like.

In an exemplary embodiment, a computer program product or a computer program is further provided. The computer program product or the computer program includes a program code. The program code is stored in a computer-readable storage medium, and a processor of a computer device reads the program code from the computer-readable storage medium. The processor executes the program code to cause the computer device to implement the above game picture display methods.

In some embodiments, a computer program according to an embodiment the disclosure may be deployed to be executed on one computer device, or on a plurality of computer devices located at one site, or on a plurality of computer devices distributed at a plurality of sites and interconnected by a communication network. The plurality of computer devices distributed at the plurality of sites and interconnected by the communication network form a blockchain system.

Those of ordinary skill in the art will appreciate that all or part of the operations for implementing the embodiments described above may be performed by hardware or by instructing relevant hardware by a program. The program is stored in a computer-readable storage medium. The above-mentioned storage medium includes a ROM, a magnetic disk, an optical disk, or the like.

The foregoing descriptions are merely optional embodiments the disclosure, but are not intended to limit the disclosure. Any modification, equivalent replacement, or improvement made within the spirit and principle the disclosure shall fall within the protection scope the disclosure.

What is claimed is:

1. A method to livestream game, performed by a livestreaming system comprising at least one server, comprising:
obtaining live operation information associated with a first player and a second player of a game session from a game server;
generating a first video stream corresponding to the first player and a second video stream corresponding to the second player based on the live operation information; and
distributing the first video stream to a first push address and the second video stream to a second push address.

2. The method according to claim 1, wherein the generating the first video stream and the second video stream comprises:
creating a simulated game session based on the live operation information;
rendering the first video stream based on the simulated game session; and
rendering the second video stream based on the simulated game session.

3. The method according to claim 2, wherein the rendering the first video stream comprises:
determining a first view of the first player; and
rendering the first video stream based on the simulated game session and the first view; and
wherein the rendering the second video stream comprises:
determining a second view of the second player; and
rendering the second video stream based on the simulated game session and the second view.

4. The method according to claim 2, wherein the creating the simulated game session based on the live operation information is performed by a cloud gaming server of the livestreaming system.

5. The method according to claim 1, further comprising:
obtaining game accounts associated with the first player and the second player; and
requesting the live operation information from the game server based on the game accounts.

6. The method according to claim 1, further comprising:
in response to a watching request, providing the first push address to an audience client.

7. The method according to claim 6, further comprising:
in response to a switching request, providing the second push address to the audience client.

8. The method according to claim 1, wherein the first video stream associated with the first player comprises visual prompt displayed to the first player.

9. The method according to claim 1, further comprising:
generating a third video stream corresponding to an observer of the game session; and
distributing the third video stream to a third push address.

10. An apparatus for livestreaming a game, the apparatus comprising:
at least one memory configured to store program code; and
at least one processor configured to read the program code and operate as instructed by the program code, the program code comprising:
first obtaining code configured to cause the at least one processor to obtain live operation information associated with a first player and a second player of a game session from a game server;
first generating code configured to cause the at least one processor to generate a first video stream corresponding to the first player and a second video stream corresponding to the second player based on the live operation information; and
first distributing code configured to cause the at least one processor to distribute the first video stream to a first push address and the second video stream to a second push address.

11. The apparatus of claim 10, wherein the first generating code comprises:
creating code configured to cause the at least one processor to create a simulated game session based on the live operation information;
first rendering code configured to cause the at least one processor to render the first video stream based on the simulated game session; and
second rendering code configured to cause the at least one processor to render the second video stream based on the simulated game session.

12. The apparatus of claim 11, wherein the first rendering code comprises:
second determining code configured to cause the at least one processor to determine a first view of the first player; and
third rendering code configured to cause the at least one processor to render the first video stream based on the simulated game session and the first view; and wherein the second rendering code comprises:
third determining code configured to cause the at least one processor to determine a second view of the second player; and
fourth rendering code configured to cause the at least one processor to render the second video stream based on the simulated game session and the second view.

13. The apparatus of claim 10, wherein the program code further comprises:
second obtaining code configured to cause the at least one processor to obtain game accounts associated with the first player and the second player; and
requesting code configured to cause the at least one processor to request the live operation information from the game server based on the game accounts.

14. The apparatus of claim 10, wherein the program code further comprises first pushing code configured to cause the at least one processor to provide the first push address to an audience client in response to a watching request.

15. The apparatus of claim 10, wherein the program code further comprises second pushing code configured to cause the at least one processor to provide the second push address to the audience client in response to a switching request.

16. The apparatus of claim 10, wherein the program code further comprises:
second generating code configured to cause the at least one processor to generate a third video stream corresponding to an observer of the game session; and
second distributing code configured to cause the at least one processor to distribute the third video stream to a third push address.

17. A non-transitory computer readable medium storing instructions that, when executed by at least one processor for livestreaming a game, cause the at least one processor to:
obtain live operation information associated with a first player and a second player of a game session from a game server;
generate a first video stream corresponding to the first player and a second video stream corresponding to the second player based on the live operation information; and
distribute the first video stream to a first push address and the second video stream to a second push address.

18. The non-transitory computer readable medium of claim 17, wherein the instructions, when executed by the at least one processor, further cause the at least one processor to:
obtain game accounts associated with the first player and the second player; and
request the live operation information from the game server based on the game accounts.

19. The non-transitory computer readable medium of claim 17, wherein the instructions, when executed by the at least one processor, further cause the at least one processor to, in response to a watching request, provide the first push address to an audience client.

20. The non-transitory computer readable medium of claim 19, wherein the instructions, when executed by the at least one processor, further cause the at least one processor to, in response to a switching request, provide the second push address to the audience client.
